(19) United States
(12) Patent Application Publication
(10) Pub. No.: US 2019/0178574 A1
(43) Pub. Date: Jun. 13, 2019

(54) CARBON DIOXIDE RECOVERY METHOD AND RECOVERY APPARATUS

(71) Applicant: IHI Corporation, Koto-ku (JP)

(72) Inventor: Toshiyuki NAITO, Tokyo (JP)

(73) Assignee: IHI Corporation, Koto-ku (JP)

(21) Appl. No.: 16/271,919

(22) Filed: Feb. 11, 2019

Related U.S. Application Data
(63) Continuation of application No. PCT/JP2017/045307, filed on Dec. 18, 2017.

(30) Foreign Application Priority Data
Jan. 20, 2017 (JP) 2017-008202

(51) Int. Cl. F25J 3/02; B01D 53/26; B01D 53/04

(52) U.S. Cl. CPC F25J 3/0266; B01D 53/261; B01D 53/0462; B01D 2256/22; B01D 2257/80; B01D 2259/402; F25J 2245/02; F25J 2205/66; F25J 2210/04; F25J 2210/70; F25J 2215/04; F25J 2220/82; F25J 2230/30; B01D 2259/40003

(57) ABSTRACT

The carbon dioxide recovery apparatus has a dryer having a hygroscopic agent for drying a gas, and a separator for separating carbon dioxide from the gas dried by the dryer and discharging a residual gas from which carbon dioxide has been separated. The recovery apparatus further includes an introduction part for introducing a regeneration gas from outside for regenerating the hygroscopic agent, a regeneration system capable of supplying one of the regeneration gas introduced from the introduction part and the residual gas discharged from the separator to the dryer, and a switching mechanism for switching supply by the regeneration system between the regeneration gas and the residual gas in response to regeneration of the hygroscopic agent.

### CROSS REFERENCE TO RELATED APPLICATIONS

This application is a continuation application of International Application No. PCT/JP2017/045307, filed on Dec. 18, 2017, which claims priority of Japanese Patent Application No. 2017-008202, filed on Jan. 20, 2017, the entire contents of which are incorporated by reference herein.

### BACKGROUND

### Technical Field

The present disclosure relates to a recovery method and a carbon dioxide recovery apparatus for separating or concentrating carbon dioxide from a carbon dioxide-containing gas such as a combustion gas.

### Description of the Related Art

In facilities such as thermal power plants, steelworks, and boilers, a large amount of fuel such as coal, fuel oil, and ultra-heavy oil is used. The release amount and concentration of sulfur oxides, nitrogen oxides, and carbon dioxide emitted by combustion of the fuel need to be restricted from the view point of air pollution prevention and global environment protection. In recent years, carbon dioxide has been considered as a main cause of global warming, and movements to suppress discharge thereof have become more active globally. For this reason, various researches have been vigorously pursued in order to make it possible to collect and store carbon dioxide of a combustion exhaust gas and a process exhaust gas, instead of releasing it into the atmosphere. As examples of carbon dioxide recovery methods, there are known a pressure swing adsorption method, a membrane separation concentration method, and a chemical absorption method utilizing reactive absorption of a basic compound.

The pressure swing adsorption (PSA) method is a separation method in which an adsorbent having selective adsorptivity for a specific component is used to adsorb the specific component in a gas and thereby separate it from the gas. The PSA method is widely known as a separation method for a mixed gas containing multiple components and can be utilized as the separation method for a mixed gas in various fields. In the PSA method, the specific component adsorbed on the adsorbent is recovered by reducing the pressure after that so as to desorb the specific component from the adsorbent, and the adsorption and the desorption are repeatedly performed. The separation efficiency of the PSA method depends on the selectivity of the adsorbent for the specific component, and the PSA method can be utilized for removing, separating, concentrating, or refining the specific component, depending on the selectivity of the adsorbent, the concentration of the specific component in a raw-material gas, and the like. Japanese Patent Application Laid-Open No. 2001-221429 (Publication Document 1 listed below) has description about oxygen produced by a PSA device which is supplied to oxygen combustion equipment.

Conventionally, as a method for recovering carbon dioxide from an exhaust gas, there has been an effective method including removing various impurities (sulfur oxides, nitrogen oxides, chlorine, mercury, and the like) from the exhaust gas and then refining the remaining concentrated carbon dioxide by cryogenic separation (liquefaction and superfractionation), and various studies have been made to put it to practical use.

Efficiency in separation and purification of carbon dioxide is influenced by moisture, and removal of moisture is effective in improving refining efficiency. Japanese Patent No. 5350376 (Publication Document 2 listed below) has description about that, in refining of a carbon dioxide-containing gas, silica gel, zeolite, porous glass, or the like is used as an adsorbent in absorption and removal of water in the presence of sulfur oxides and nitrogen oxides.

### DOCUMENTS LIST

Publication Document 1: Japanese Patent Application Laid-Open No. 2001-221429

Publication Document 2: Japanese Patent No. 5350376

### BRIEF SUMMARY

In the case of exhaust gas having a relatively high concentration of carbon dioxide and a low content of various impurities (sulfur oxides, nitrogen oxides, chlorine, mercury, etc.), the recovery method by cryogenic separation (liquefaction and superfractionation) is efficient. Carbon dioxide can be recovered suitably by subjecting the exhaust gas to drying treatment and then performing a cryogenic separation. Accordingly, a residual gas obtained after the separation of carbon dioxide contains substantially no moisture. A hygroscopic agent used in the dehumidification processing can be regenerated and used repeatedly by being heated or by being supplied with a dry gas. Thus the hygroscopic agent can be regenerated by utilizing the residual gas obtained after the carbon dioxide separation.

However, in an actual condition of exhaust gas processing, the amount of the residual gas obtained after the carbon dioxide separation fluctuates. Moreover, when the exhaust gas with a high carbon dioxide concentration is processed, the amount of the residual gas is insufficient for the regeneration of the hygroscopic agent. Therefore, in order to stably regenerate the hygroscopic agent, it is preferable to use a regeneration gas introduced from the outside. However, in view of energy efficiency, it is preferable to reuse the residual gas in some way.

An object of the present disclosure is to solve the aforementioned problems and provide a carbon dioxide recovery method and a recovery apparatus which can stably and economically perform processing by stably regenerating the hygroscopic agent used for recovering carbon dioxide from the carbon dioxide-containing gas and effectively utilizing the residual gas after recovering the carbon dioxide.

As a result of earnest research conducted on the situation of carbon dioxide recovery processing to solve to the aforementioned problems, the inventors have reached a configuration of effectively use the pressure and the cold of the residual gas after recovering the carbon dioxide and capable of favorably recovering carbon dioxide immediately after regenerating the hygroscopic agent, thus completing the technology of the present disclosure.

According to one aspect of the present disclosure, a carbon dioxide recovery apparatus includes: a dryer having a hygroscopic agent for drying a gas; a separator which separates carbon dioxide from the gas dried by the dryer and discharges a residual gas from which carbon dioxide has been separated; an introduction part which introduces from outside a regeneration gas for regenerating the hygroscopic agent; a regeneration system capable of supplying one of the regeneration gas introduced from the introduction part and the residual gas discharged from the separator, to the dryer; and a switching mechanism which switches supply by the regeneration system between the regeneration gas and the residual gas in response to regeneration of the hygroscopic agent.

The recovery apparatus may be configured to further include: a recirculating system capable of supplying the residual gas discharged from the separator to the gas to be supplied to the separator, wherein the switching mechanism switches supply by the recirculating system so that the residual gas is supplied to the gas to be supplied to the separator while the regeneration gas is supplied to the dryer by the regeneration system.

The switching mechanism can be configured to include: a control system which controls switching so that the regeneration gas is supplied to the dryer at a start of regeneration of the hygroscopic agent and the residual gas is supplied to the dryer at an end of regeneration of the hygroscopic agent to replace the regeneration gas with the residual gas. Moreover, the control system may be configured to have a hygrometer which detects humidity of the regeneration gas discharged from the dryer and control the switching based on the humidity detected by the hygrometer.

The recovery apparatus can be configured to further include: a compressor which compresses the gas to be supplied to the separator to pressurize the gas to a pressure suitable for separation of carbon dioxide by the separator; and a heat exchanger which performs heat exchange between the gas whose temperature has been increased by compression by the compressor and one of the residual gas and the regeneration gas to be supplied to the dryer, wherein the one of the regeneration gas and the residual gas is heated by the heat exchanger, and the gas is cooled. In a configuration in which the separator includes a cryogenic-type liquefaction distillation apparatus, an advantageous recovery apparatus can be provided.

The recovery apparatus can be configured to further include: a heater which complementarily heats the regeneration gas heated by the heat exchanger; and an adjustment mechanism which adjusts heating of the regeneration gas by the heater. The adjustment mechanism may adjust heating by the heater so that the regeneration gas decreases in temperature as regeneration of the hygroscopic agent progresses. The adjustment mechanism is capable of adjusting the heating by the heater based on humidity of the regeneration gas discharged from the dryer.

The separator has a discharge part for discharging the residual gas. The switching mechanism has a switching valve capable of switching a connection to the dryer between the discharge part of the separator and the introduction part, and such a configure is possible that the switching valve is controlled according to the humidity detected by the hygrometer.

Moreover, according an aspect of the present disclosure, a carbon dioxide recovery method includes: drying treatment of drying a gas by using a hygroscopic agent; separation processing of separating carbon dioxide from the gas dried by the drying treatment and of discharging a residual gas from which carbon dioxide has been separated; regeneration treatment of supplying to the hygroscopic agent a regeneration gas introduced from outside to regenerate the hygroscopic agent; switching processing of switching the regeneration gas supplied to the hygroscopic agent into the residual gas in accordance with progress of the regeneration of the hygroscopic agent.

According to the present disclosure, carbon dioxide recovery method and recovery apparatus which can stably and economically perform recovery processing can be provided, by stably carrying out the regeneration of the hygroscopic agent used for recovering carbon dioxide from the carbon dioxide-containing gas while effectively utilizing the residual gas after the carbon dioxide recovery. Therefore, the economic efficiency and versatility in the recovery of carbon dioxide are increase, which is effective for expanding the application field.

### BRIEF DESCRIPTION OF DRAWINGS

FIG. 1 is a schematic configuration diagram illustrating a carbon dioxide recovery apparatus according to one embodiment of the present disclosure.

### DETAILED DESCRIPTION OF EMBODIMENTS

The cryogenic separation method is a method for separating and purifying carbon dioxide contained in a gas by liquefaction and superfractionation. In the case of exhaust gas having a relatively high concentration of carbon dioxide and a small content of various impurities (sulfur oxides, nitrogen oxides, chlorine, mercury, etc.), in particular, carbon dioxide can be efficiently recovered from the exhaust gas by the cryogenic separation method. From the exhaust gas, concentrated (or purified) carbon dioxide and the residual gas (gas with decreased carbon dioxide concentration) are obtained.

The exhaust gas after subjected to drying treatment is supplied to a separator so that separation and recovery of carbon dioxide is not inhibited. A hygroscopic agent is used in the drying treatment, and the hygroscopic agent after use can be used repeatedly by being heated or being supplied with a dry gas. Since the residual gas after separation of carbon dioxide in the separator is substantially free of moisture, it is possible to regenerate the hygroscopic agent using the residual gas. However, the amount of the residual gas after the separation of carbon dioxide depends on the amount of carbon dioxide contained in the exhaust gas, and the residual gas amount fluctuates as the carbon dioxide content of the exhaust gas increases or decreases.

Therefore, in the present disclosure, a recovery apparatus is configured so that a necessary amount of regeneration gas can be supplied to the hygroscopic agent from the outside, in order to stably perform the repetitive regeneration of the hygroscopic agent. Furthermore, for a new method for effectively utilizing the residual gas, the regeneration gas in contact with the hygroscopic agent at the end of the regeneration of the hygroscopic agent is replaced with the residual gas to prevent the decrease in the concentration of carbon dioxide in the initial gas switched from regeneration to drying. In other words, decrease in the amount of carbon dioxide recovered from the gas supplied to the separator is suppressed during the regeneration/drying switching. At the other times, the residual gas is added to the gas to be supplied to the separator. The gas to be supplied to the separator according to the cryogenic separation is pressurized to a pressure suitable for liquefaction, and the residual gas discharged from the separator is in a pressurized state. Therefore, it is possible to increase the gas pressure by adding the residual gas to the gas while maintaining the pressure of the pressurized residual gas. That is, the energy for pressurizing the gas to be supplied to the separator can be reduced. Hereinafter, a method for recovering carbon dioxide and a recovery apparatus for implementing the method according to the present disclosure will be described with reference to the drawing.

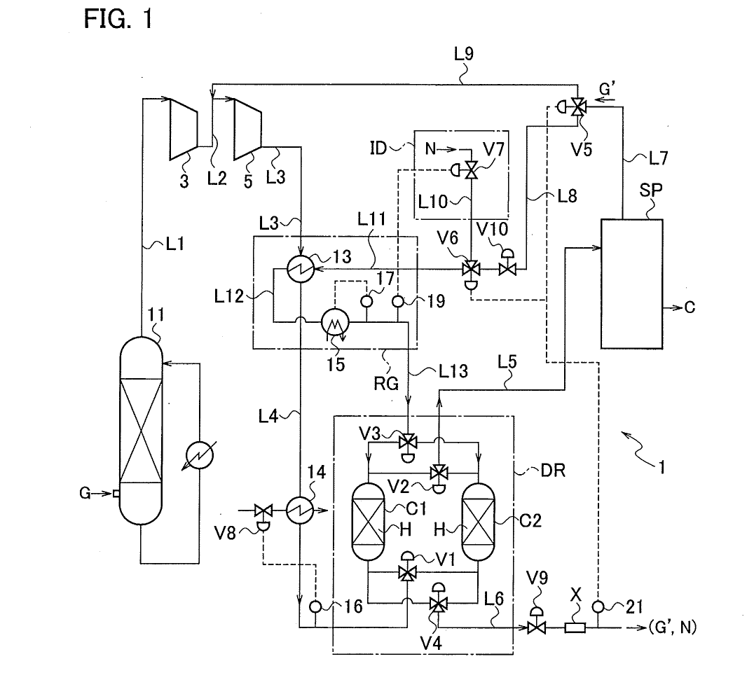

FIG. 1 is a schematic configuration diagram showing an embodiment of a recovery apparatus for carbon dioxide of the present disclosure. The recovery apparatus 1 for carbon dioxide has a dryer DR having a hygroscopic agent H for drying the gas G, and a separator SP which separates carbon dioxide C from the gas G dried by the dryer DR and discharges a residual gas G′ from which carbon dioxide has been separated. Further, the recovery apparatus 1 includes an introduction part ID for introducing the regeneration gas N for regenerating the hygroscopic agent H from the outside, a regeneration system RG capable of supplying the regeneration gas or the residual gas G′ to the dryer DR, and a switching mechanism for switching supply by the regeneration system RG. The regeneration system RG is capable of supplying, to the dryer DR, one of the regeneration gas N introduced by the introduction part ID and the residual gas G′ discharged from the separator SP, and the supply by the regeneration system RG is switched between the regeneration gas N and the residual gas G′ according to the progress of regeneration of the hygroscopic agent H.

The separator SP includes a cryogenic liquefaction distillation apparatus which separates carbon dioxide from the gas G and purify it by cryogenic separation, whereby liquefaction and superfractionation are carried out. The gas G is pressurized to a pressure suitable for liquefaction of carbon dioxide before it is supplied to the separator SP. For this purpose, compressors 3 and 5 are provided as a pressuring device for imparting to the gas G a pressure at which carbon dioxide can be liquefied. Separation by cryogenic separation can be used for treating gases having a high carbon dioxide concentration such that carbon dioxide concentration is about 80 to 90%, and it is capable of recovering highly purified carbon dioxide C. The residual gas G′ discharged from the separator SP has a lower carbon dioxide concentration than the supplied gas G, but generally contains about 30% of carbon dioxide. The separator SP has therein a heat exchanger for heat exchange between the supplied gas G and the residual gas G′, so that the residual gas G′ is discharged at a temperature close to the temperature of the supplied gas G and reduction in utilization efficiency of cold energy at the inside is suppressed.

The dryer DR has the hygroscopic agent H for drying the gas G to be supplied to the separator SP, and the hygroscopic agent H is accommodated in at least one pair of columns C1, C2. The gas G pressured by the compressors 3, 5 is dehumidified by the hygroscopic agent H of the dryer DR and then supplied to the separator SP. The hygroscopic agent H which has absorbed moisture can be regenerated by heating or supplying a dry gas.

Since the gas G supplied to the separator SP is dry, the residual gas G′ after removal of carbon dioxide in the separator SP is substantially free of moisture. Therefore, the residual gas G′ can also be used as a regeneration gas for regenerating the hygroscopic agent H of the dryer DR. However, in the present disclosure, the regeneration system RG mainly uses the regeneration gas N introduced from the outside to regenerate the hygroscopic agent H of the dryer DR. For this purpose, an introduction part ID capable of constantly supplying the regeneration gas N in a predetermined amount is provided. The regeneration gas N supplied from the outside is a gas whose moisture content is in such a level that is usable for regenerating the hygroscopic agent H, and those that do not substantially affect the performance of the hygroscopic agent are usable. Therefore, a gas composed of an inert component such as nitrogen is suitably used as the regeneration gas N. The regeneration gas N need not be a single component gas as long as it is available for regeneration of the hygroscopic agent H, and it may be a mixed composition of a plurality of components. For example, nitrogen gas discarded from an oxygen production apparatus (ASU: Air Separation Unit) can be used as it is because it has a water content of about 1 to 2 ppm, and it is useful as the regeneration gas N. Further, air or the like discharged from facilities subjected to air conditioning is in a dry state and also available as the regeneration gas N. The flow rate of the regeneration gas N supplied from the outside to the dryer DR by the introduction part ID is maintained at a constant amount and the regeneration in the dryer DR is constantly and stably carried out, so that it is possible to avoid the influence of the regeneration failure of the hygroscopic agent H on the separator SP. In order to improve the regeneration efficiency, a device for heating the regeneration gas N is provided and the configuration is devised to increase the thermal efficiency.

Since the regeneration gas N introduced from the outside has a low or substantially no carbon dioxide content, the supply to the hygroscopic agent H is switched from the regeneration gas N to the residual gas G′ at the stage when the regeneration of the hygroscopic agent H approaches completion in the dryer DR. As a result, the regeneration gas N in contact with the hygroscopic agent H in the column is replaced with the residual gas G′, and the carbon dioxide concentration of the gas rises. Therefore, when switching of regeneration/drying is performed in this state, temporary decrease in carbon dioxide of the gas G supplied from the dryer DR to the separator SP can be suppressed. Thus reduction in the amount of carbon dioxide recovered in the separator SP is suppressed. Since the residual gas G′ is in a dry state that can be used as a regeneration gas, the supply switching of regeneration gas N/residual gas G′ may be performed either at the completion of regeneration of the hygroscopic agent H or before the end of regeneration. The completion of the regeneration of the hygroscopic agent H can be judged based on the measured value, with measuring of the humidity of the regeneration gas N discharged from the column during the regeneration. When the carbon dioxide content of the gas G is high, the flow rate of the residual gas G′ decreases remarkably. Therefore, it is suitable to switch to the drying treatment at the stage of having replaced appropriately with the residual gas G′.

A specific configuration of the recovery apparatus 1 in FIG. 1 is described below. It is noted that broken lines in FIG. 1 illustrate electrical connections. The recovery apparatus 1 includes a cooler 11. The gas G containing carbon dioxide is first supplied to the cooler 11. The cooler 11 is equipment for cooling the gas G discharged from the combustion facility or the like at a high temperature to a temperature suitable for processing in the subsequent equipment and is configured to cool the gas G to a temperature of about 50° C. or less, preferably about 40° C. or less at the outlet. The temperature of the combustion exhaust gas at the inlet is generally about 100 to 200° C. Since the volume of the gas decreases by cooling, this makes it possible to increase the processing amount in subsequent equipment. A coolant may be any generally-used coolant such as water, air, or a coolant for refrigeration cycle. Regarding the contact with the coolant, any type of cooling may be employed, such as those of a direct-contact type such spraying, gas-liquid contact using a packing, etc., those of indirect-contact type using a condenser, a heat exchanger, or the like. In this embodiment, a scrubber which cools the gas G by bringing the gas G into direct contact with cooling water is provided as the cooler 11. The direct-contact cooling using cooling water is excellent in economy and cooling efficiency and also has a function of cleaning means for removing fine solid matters such as dust and acid substances such as chlorides and sulfur oxides, from the gas G.

The cooler 11 is connected in series with the compressors 3, 5 via flow passages L1, L2. The gas G whose temperature is adjusted to a suitable temperature by the cooler 11 is supplied to the compressors 3, 5 and compressed, whereby the pressure thereof is increased. The compressors 3, 5 are operated by a power source (not shown) such as, for example, a motor, and applies to the gas G a pressure required for the liquefaction of the carbon dioxide in the subsequent separator SP. Specifically, since carbon dioxide can be liquefied when compressed at a pressure equal to or higher than the boiling line in the temperature range from the triple point to the critical point, the gas G is compressed by the compressors 3, 5 so that the gas G supplied to the separator SP has a pressure that is equal to or higher than the triple point, preferably about 2.0 to 4.0 MPa. In this embodiment, pressurization is performed by two stages of compressors, but it is also possible to provide in only one stage or provide a plurality of compressors configured in three or more stages. Further, the compressors 3, 5 may be replaced with other pressurizing devices such as a pressurizing pump, a blower or the like, and any pressure applying means capable of generating a flow pressure capable of pressurizing the gas G can be used. The pressure applied to the gas G by the compressors 3, 5 can be maintained in the separator SP by providing a pressure control valve in the separator SP or downstream of the separator SP, and the pressure of the gas G can be adjusted by controlling the pressure control valve. In this embodiment, the pressure is maintained by a pressure control valve V10 attached to a flow passage L8 through which the residual gas G′ discharged from the separator SP flows, but the present disclosure is not limited thereto. The temperature of the gas G rises by pressurization in the compressors 3, 5. For example, when the gas G whose temperature is 50° C. and whose carbon dioxide concentration is 80% (volume percent) is pressurized to about 2.5 MPa, the temperature of the gas G in this case is about 250° C. In this manner, when the compression ratio of the gas G by the compressors 3, 5 is appropriately adjusted, the temperature of the gas G after the pressure increase is generally increased to about 180 to 250° C.

The compressor 5 is connected to a heat exchanger 13 through a flow passage L3. The pressurized gas G is cooled in the heat exchanger 13 by the regeneration gas N supplied from the introduction part ID or the residual gas G′ discharged from the separator SP. As a result, the regeneration gas N and the residual gas G′ are heated to a temperature suitable for regeneration treatment of the hygroscopic agent H (details will be described later).

In the case where the gas G contains nitrogen oxide, it is preferred to remove the nitrogen oxide within a possible range in consideration of the influence on the separation efficiency of the separator SP. In such a case, it is advisable to provide a denitration apparatus in the flow passage L3. The denitration apparatus includes devices of dry denitration using a solid absorbent, an adsorbent, or a catalyst, and devices of wet denitration using an aqueous liquid containing a basic substance, and it can be used by appropriately selecting from those of denitration types generally used for denitration of exhaust gas. For example, a catalyst which decomposes nitrogen oxide into nitrogen by reacting it with ammonia is suitably used. Moreover, nitrogen monoxide included in the nitrogen oxides has extremely low water solubility and it is thus difficult to dissolve and remove with water alone. However, since the gas G is pressurized by the compressors 3, 5 in the embodiment of FIG. 1, it is possible to perform dissolution and removal with water by utilizing reaction progress by pressurization. Specifically, oxidation of nitric oxide proceeds in the pressurized gas G and it is converted into nitrogen dioxide with high water solubility. And at the same time, the water vapor in the gas G is condensed by the pressurization. Therefore, the nitrogen oxides contained in the gas G dissolve in the condensed water as nitrogen dioxide. Thus the denitration treatment of the gas G can be made by separating and removing the condensed water from the pressurized gas G using a gas-liquid separator or the like. In this treatment system, the basic substance is unnecessary and the moisture content of the gas G is reduced, so that the burden on the dryer DR in the subsequent stage is reduced. In the case where the heat exchanger 13 has corrosion resistance or when the amount of nitrogen oxides contained in the gas G is relatively small, the aforementioned denitration apparatus can be disposed at the stage subsequent to the heat exchanger 13. In this case, since the amount of the condensed water separated and removed by the cooling of the pressurized gas G increases, the water content of the gas G decreases, and the burden of the drying treatment in the dryer DR is reduced.

The heat exchanger 13 is connected to the dryer DR via a flow passage L4, and a cooler 14 of water-cooled type is provided on the flow passage L4. Therefore, the gas G is further cooled by the cooler 14 and its temperature decreases to a temperature suitable for the drying treatment in the dryer DR. The degree of cooling by the cooler 14 is adjusted by a flow regulating valve V8 which adjusts the flow rate of the cooling water supplied to the cooler 14. A thermometer 16 is attached on the flow passage L4, and the flow regulating valve V8 is controlled based on the temperature detected by the thermometer 16. The cooled gas G is subjected to the drying treatment by the dryer DR. The dryer DR is equipment for removing moisture from the gas G to prevent deterioration of the separation efficiency in the separator SP, and is particularly important in the case where the cooler 11 in the previous stages is configured by using a wet type device. The dryer DR has the columns Cl, C2 containing the hygroscopic agent H therein. The gas G is dehumidified by being brought into contact with the hygroscopic agent H, and the gas G with low humidity is supplied to the separator SP via a flow passage L5. The hygroscopic agent H may be appropriately selected and used from commonly used desiccant materials such as silica gel, alumina gel, molecular sieve, zeolite, activated carbon and the like. A hygroscopic agent which can be easily regenerated by heating such as silica gel and the like is economically advantageous and can form a temperature-swing moisture absorbing tower. Forming the dryer DR by using one pair or more of moisture absorbing columns loaded with the hygroscopic agent H enables alternate performance of moisture absorption of the gas G and the regeneration of the hygroscopic agent H in each moisture absorbing column by supplying the gas G and the high-temperature regeneration gas alternately to each moisture absorbing column. In other words, the drying treatment and the regeneration of the hygroscopic agent H can be repeatedly and continuously performed without stopping the processing of the gas G. This is achieved by performing switching control of switching valves V1, V2, V3 and V4. Controlling the switching valves V1, V2 such that the flow passages L4, L5 communicate with one of the columns C1, C2 causes the gas G supplied from the flow passage L4 to be dehumidified in the one of the columns C1, C2 and supplied to the separator SP via the flow passage L5. At this time, the connection of the switching valves V3, V4 is controlled such that the regeneration gas N supplied to the dryer DR flows through the other column and is discharged from a flow passage L6. By reversing the connection of the switching valves V1, V2, V3 and V4, the moisture absorption and the regeneration in the columns C1, C2 are switched. The switching valves V1, V2, V3 and V4 may be configured to be automatically switched depending on the moisture concentration of the gas G discharged from the flow passage L5. For example, such a configuration can be given that a concentration sensor is provided in the flow passage L5 to be electrically connected to the switching valves V1, V2, V3 and V4 and that respective switching of the switching valves V1, V2, V3 and V4 is performed based on an increase in the moisture concentration detected by the concentration sensor so as to change the column communicating with the flow passage L4 and the flow passage L5.

The main part of the separator SP is constituted by a low-temperature distillation column and a cooling heat exchanger. Due to the supply of the gas G, the gas G is cooled to a temperature equal to or lower than the boiling curve, preferably −20 to −50° C., and the carbon dioxide in the gas G is liquefied. The liquefied carbon dioxide is preferably prepared in a supercritical state and distilled at a temperature of about −20 to −50° C. in the low-temperature distillation column to remove impurities such as oxygen, nitrogen and argon from the liquefied carbon dioxide. Carbon dioxide gas in which proportion of these impurities has increased is discharged from the low-temperature distillation column as the residual gas G′. That is, the gas G supplied from the dryer DR to the separator SP through the flow passage L5 is separated into the concentrated or refined carbon dioxide C and the residual gas G′ with reduced carbon dioxide. The concentrated or refined carbon dioxide C is recovered from the separator SP and carbon dioxide C liquefied and refined to a purity of generally about 95 to 99% is possibly obtained. Before discharged from a discharge part of the separator SP, the residual gas G′ is subjected to heat exchange with the supplied gas G to cool the gas G, so that it can improve the utilization efficiency of cold heat.

The discharge part of the separator SP is connected to a switching valve VS through a flow passage L7. The switching valve V5 is connected, on one hand, to the regeneration system RG and the dryer DR through the flow passage L8 and a switching valve V6, and on the other hand, to the flow passage L2 through a flow passage L9. Therefore, the residual gas G′ flows through either the flow passage L8 or the flow passage L9 by switching of the switching valve V5. When the switching valve V5 connects the flow passage L7 and the flow passage L9, the residual gas G′ discharged from the separator SP merges with the gas G in the flow passage L2 through the flow passage L9 and is supplied to the compressor 5. In other words, the flow passage L9 functions as a recirculating system capable of supplying the residual gas G′ discharged from the separator SP, to the gas G supplied to the separator SP. Since the residual gas G′ is in a pressurized state, introducing this into the flow passage L2 between the compressor 3 and the compressor 5 increases the pressure of the gas G supplied from the compressor 3 to the compressor 5. Therefore, it is possible to decrease the setting of the compression ratio in the compressor 5. The pressure of the gas G increases according to the number of stages of the compressor. Therefore, in the case of configuring the compressor in three or more stages, the reflux position of the residual gas G′ is set so that the efficiency of the compressor becomes favorable. Since the residual gas G′ has a lower carbon dioxide concentration than the gas G and contains impurities, it is advisable to add the residual gas G′ to the gas G within a range that does not reduce the recovery ratio in the separator SP so much.

The introduction part ID for introducing the regeneration gas N has a flow passage L10 and a flow regulating valve V7, and the flow rate of the regeneration gas N supplied from the flow passage L10 can be regulated by the flow regulating valve V7. The flow passage L10 is a line for introducing the external regeneration gas N into the recovery apparatus 1 and supplying it to the dryer DR. As the regeneration gas N, used is one having such moisture content as it is usable for regenerating the hygroscopic agent H, for example, a moisture content of about 1 ppm or less. For example, nitrogen gas discharged from an oxygen production apparatus (ASU) or the like is used as the regeneration gas N and it is introduced at a temperature of about room temperature or lower. The flow passage L10 is connected to a flow passage L11 of the regeneration system RG via a switching valve V6. Accordingly, the switching valve V6 can switch the connection to the dryer DR between the discharge part of the separator SP and the introduction part ID. By the connection switching of the switching valve V6, one of the regeneration gas N and the residual gas G′ discharged from the separator SP is supplied to the dryer DR through the flow passage L11. As the flow regulating valve V7, a solenoid valve or the like whose operation can be electrically controlled is used. The flow regulating valve V7 is electrically connected to a flowmeter 19 (described later) and is adjusted so that the flow rate of the regeneration gas detected by the flowmeter 19 is maintained at a predetermined flow rate. In the embodiment shown in FIG. 1, the pressure of the pressurized gas G is adjusted by the pressure control valve V10 installed on the downstream side (on the flow passage L8) of the switching valve V5, and the pressure of the regeneration gas N and the residual gas G′ supplied to the dryer DR can be arbitrarily adjusted by a pressure control valve V9 on the flow passage L6 which discharges the used regeneration gas N from the dryer DR. Since regeneration treatment of the hygroscopic agent H tends to proceed at a low pressure, it is advisable to introduce the regeneration gas N at a normal pressure or in a state pressurized lower than the pressure of the pressurized gas G. Nitrogen gas which is provided from the oxygen production apparatus generally at a pressure of about 0.1 to 0.4 MPa can be introduced as the regeneration gas as it is. In this case, it is advisable to introduce the regeneration gas N and the residual gas G′ with equal pressure. However, the present disclosure is not limited to this. For example, such a configuration is also usable that the pressure control valve V10 on the flow passage L8 is omitted and the pressures of the pressurized gas G and the residual gas G′ are maintained and adjusted by the pressure control valve V9 on the flow passage L6 which discharges the regeneration gas from the dryer DR. In this case, it is advisable to introduce the regeneration gas N while adjusting the pressure to the same level as the residual gas G′.

The regeneration system RG which regenerates the hygroscopic agent H of the dryer DR using the regeneration gas N has flow passages L11 to L13 and a heater for heating the regeneration gas N to a high temperature. Specifically, the flow passage L11 is connected to the aforementioned heat exchanger 13, and the heat exchanger 13 is disposed so as to perform heat exchange between the gas G in the flow passage L3 and the regeneration gas G in the flow passage L11. Since the temperature of the gas G rises by applying pressure in the compressors 3, 5, the regeneration gas N (or the residual gas G′) in the flow passage L11 is heated by heat exchange on indirect contact with the gas G of high temperature in the heat exchanger 13. That is, the heat exchanger 13 cools the compressed gas G in the flow passage L3 and recovers and use the heat of the gas G to heat the regeneration gas N in the flow passage L11. The regeneration gas N acts as a heating medium for carrying the thermal energy of the pressurized gas G to the dryer DR. The gas G of high temperature is cooled to about 50 to 70° C. in the heat exchanger 13 and is pumped to the dryer DR and the separator SP. The cooled temperature of the gas G can also be reduced to about 30 to 40° C. or lower by the heat exchange rate of the heat exchanger 13. The regeneration gas N of about 20 to 40° C. and the residual gas G′ returned from the separator SP are heated to about 150 to 200° C. The heat exchanger 13 may be configured by using a known gas-to-gas heat exchanger. It may be of any form such as a counter-flow type, a parallel-flow type or a crossflow type. For example, it can be appropriately selected from static heat exchangers, rotary regenerative heat exchangers, periodic flow regenerative heat exchangers and the like. By, supplying the heated regeneration gas N to the columns C1 and C2, moisture is released from the hygroscopic agent H after use.

The regeneration system RG further has a heater which complementarily heats the regeneration gas N as necessary and an adjustment mechanism which regulates the heating of the regeneration gas by the heater. Specifically, it has a heater 15 installed on the downstream side of the heat exchanger 13 and a detector 17 installed at the downstream side of the heater 15, and the detector 17 is electrically connected to the heater 15. The heater 15 connected to the downstream side of the heat exchanger 13 by a flow passage L12 is connected to the switching valve V3 of the dryer DR through a flow passage L13. Therefore, the regeneration gas N which has been heated by the heat exchanger 13 and heated supplementarily by the heater 15 is supplied to the column of the dryer DR. The detector 17 detects the temperature of the regeneration gas N to be supplied to the dryer DR through the flow passage L13, and the heater 15 is controlled based on the detected temperature at the detector 17. By this control, the regeneration gas N is heated by the heater 15 when the temperature of the regeneration gas N after the heat exchange has not reached the optimum temperature for the regeneration of the hygroscopic agent H. The regeneration gas supplied to the dryer DR is a high-temperature dry gas having a temperature of about 150 to 200° C., containing almost no moisture and having a dew point of about −90 to −60° C. The flowmeter 19 is installed on the flow passage L13 and is electrically connected to the flow regulating valve V7 of the introduction part ID. The flowmeter 19 detects the flow rate of the regeneration gas supplied to the dryer DR through the flow passage L13, and the flow regulating valve V7 is controlled based on the gas flow rate detected by the flowmeter 19 so that the flow rate of the regeneration gas is maintained at a predetermined flow rate. Therefore, the flow rate of the regeneration gas N supplied to the dryer DR is adjusted to the predetermined flow rate. Accordingly, the regeneration gas N is stably supplied to the dryer DR, and the influence on the separator SP due to reduction in the efficiency of the drying treatment and regeneration failure of the hygroscopic agent H is avoided. The regeneration gas N (or the residual gas G′) containing moisture by the regeneration of the hygroscopic agent H in the dryer DR is discharged from the flow passage L6 to the outside via the switching valve V4, the pressure control valve V9 and a silencer X, and the pressure of the regeneration gas N (or the residual gas G′) is released to atmospheric pressure. In this embodiment, the pressure applied by the compressors 3, 5 is maintained through the dryer DR and the separator SP up to the pressure control valve V10 of the flow passage L8. And regarding the regenerating side of the dryer DR, the pressure of the regeneration gas N and the residual gas G′ is regulated by the pressure control valve V9. If the regeneration gas N (and the residual gas G′) is used for regeneration at atmospheric pressure, the pressure control valve V9 of the flow passage L6 can be omitted.

In the above-described configuration, the gas supplied from the regeneration system RG to the dryer DR can be replaced between the regeneration gas N introduced from the outside and the residual gas G′ discharged from the separator SP, by switching the connection of the switching valves V5, V6. A hygrometer 21 is attached to the flow passage L6 which discharges used regeneration gas from the dryer DR, and the switching valves V5, V6 are electrically connected to the hygrometer 21. While regenerating the hygroscopic agent H in one of the columns of the dryer DR, the connection of the switching valves V5, v6 is set so that the regeneration gas N is supplied to the dryer DR. When the regeneration treatment is progressed and the regeneration is completed, humidity decrease of the used regeneration gas N flowing through the flow passage L6 is detected by the hygrometer 21. In response to this, the connection of the switching valves V5, V6 is switched, and the residual gas G′ is supplied from the regeneration system RG to the dryer DR in place of the regeneration gas N. That is, the switching valves V5, V6 and the hygrometer 21 act as a switching mechanism that switches the supply by the regeneration system RG between the regeneration gas N and the residual gas G′ in accordance with regeneration of the hygroscopic agent H. In the switching mechanism, a control system is constituted by the electrical connection of the switching valves V5, V6 and the hygrometer 21. The control system controls the connection switching of the switching valves V5, V6 based on the humidity detected by the hygrometer 21, and the regeneration gas N is supplied to the dryer at a start of regeneration of the hygroscopic agent. The residual gas G′ is supplied to the dryer DR at an end of regeneration of the hygroscopic agent H to replace the regeneration gas N with the residual gas G′. The switching mechanism also switches the supply destination of the residual gas G′ by the recirculating system (flow passage L9). That is, while the regeneration gas N is supplied to the dryer DR by the regeneration system RG, the residual gas G′ is supplied to the gas G to be supplied to the separator SP.

Since the flow rate of the regeneration gas N is suitably maintained, the time required for the regeneration of the hygroscopic agent H is stabilized, and the hygroscopic capacity of the hygroscopic agent H can be fully utilized. However, since the generation gas N has a low or substantially no content of carbon dioxide, the concentration of carbon dioxide in the gas in the column is drastically reduced by the regeneration treatment of the hygroscopic agent H. If the drying treatment starts on the column that the regeneration has been completed in this state, a gas having a very low carbon dioxide concentration is supplied to the separator SP, which tends to affect the recovery amount and the purity of carbon dioxide. However, as described above, substitution with the residual gas G′ at the end of regeneration of the hygroscopic agent H allows continuation of good recovery of carbon dioxide.

Regarding the connection switching of the switching valves V5, V6 based on the detected humidity of the hygrometer 21, humidity of the used regeneration gas N as a reference value for judging the completion of regeneration of the hygroscopic agent H is set in advance by utilizing experimental data, simulation, etc. The moisture content of the used regeneration gas N is generally about 10 to 100 ppm, and the reference value is set based on such data. Then the reference value is compared with the detected humidity of the hygrometer 21. When these are matched, it is determined that the regeneration has been completed, and the connection of the switching valves V5, V6 is switched. That is, the switching timing can be changed and adjusted by the setting of the reference value. And, if the reference value is increased, the connection is switched at an earlier timing than the actual completion of regeneration. Since the residual gas G′ can be used as the regeneration gas, the switching timing may be earlier than the actual regeneration completion, and in this case, it is possible to complete the regeneration of the hygroscopic agent H while the regeneration gas N is replaced with the residual gas G′. However, the time required for replacement with the residual gas G′ is short, and the flow rate of the residual gas G′ discharged from the separator SP may vary depending on the carbon dioxide content of the gas G. Therefore, there is a possibility that the supply amount of the regeneration gas is insufficient. From this point of view, a set value of humidity and setting of switching timing are preferably such that the time difference between the switching timing and the actual regeneration completion is not so large.

In order to continuously and efficiently perform the drying treatment of the gas G in the dryer DR, it is important that the time required for the regeneration treatment of the hygroscopic agent H is equal to or shorter than the period of time during which the absorbed moisture amount of the hygroscopic agent H reaches the moisture absorption capacity in the drying treatment (time during which the drying treatment can be continued). Since the time required for the regeneration treatment varies depending on the supply flow rate of the regeneration gas N, it is possible, by adjusting the setting of the flow regulating valve V7, to maintain the supply flow rate of the regeneration gas N such that the regeneration treatment is completed within the time period during which the drying treatment can be continued. In a situation where the time required for completing the regeneration of the hygroscopic agent H cannot be shortened to the time during which the drying treatment can be continued or less, it is possible to set the time to end the regeneration, for example, by considering, as the regeneration completion, the state of the regeneration degree that can proceed in the time when the drying treatment can be continued.

Moreover, from the viewpoint of utilization efficiency of the regeneration gas N and the residual gas G′, it is suitable to set the sum of the time during which the drying treatment can be continued and the time required for replacing by the residual gas G′ so as to reduce the difference from the time required for the regeneration treatment. It is optimum that the sum of the time required for the regeneration treatment and the time required for the replacement by the residual gas G′ is equal to the time during which the drying treatment can be continued. In such a setting, the time difference between the switching timing of the switching valves V5, V6 (supply switching time of the regeneration gas N and the residual gas G′) and the switching timing of the switching valves V1 to V4 (switching timing of the drying treatment/regeneration treatment) is the time required for replacement by the residual gas G′.

Heating is unnecessary for replacing the gas in the column with the residual gas G′. Considering the switching to the drying treatment, the temperature of the residual gas G′ supplied to the dryer DR is suitably low. Therefore, it is appropriate to change the control system so that, when the regeneration of the hygroscopic agent H is completed, heating of the heater 15 is stopped while switching of the switching valves V5, V6 is carried out. This change can be made based on the humidity of the used regeneration gas N using the detection value of the hygrometer 21, but it is also possible by previous setting so as to limit the heating time of the heater 15 to a predetermined time. Further, the adjustment mechanism may be modified to adjust the heating such that the amount of heating by the heater 15 is decreased and the temperature of the regeneration gas N is lowered as the regeneration of the hygroscopic agent H progresses. Such modification can be made based on the humidity of the used regeneration gas N using the detection value of the hygrometer 21.

In the case where the gas G supplied to the recovery apparatus 1 has already been subjected to water-washing treatment or cooling treatment at other facilities and removal of unnecessary materials or cooling is not required, the cooler 11 may be omitted. When it is necessary to enhance the cooling of the gas G from the viewpoint of the optimum temperatures in the dryer DR and the separator SP, it is appropriate to add a cooler to a proper position such as the downstream side of the heat exchanger 13 in the flow passage L4 or on the flow passage L5. It can be cooled to a temperature of about 20 to 30° C. or lower by a water-cooled type cooler using cooling water of about 5 to 25° C. as a coolant.

In addition, the number of columns in which the hygroscopic agent H is stored in the dryer DR may be appropriately changed so as to perform suitable drying treatment according to the moisture absorption rate, moisture absorption capacity, regeneration speed, etc. of the hygroscopic agent H to be used. By increasing the number of columns, it is possible to use hygroscopic agents with lower absorption capacity. Further, when a column containing the hygroscopic agent H is additionally provided on the flow passage L5, it is possible to cope with temporary drying failure caused by control failure or the like.

With the above configuration, such application is also possible as to use a computation processing device such as a CPU to manage the information detected by the flow meters, hygrometers, etc. in the computation processing device while automatic control of switching valves, flow regulating valves, etc. is performed based on the detected information. This enables complicated processing such as operation correction through compensation based on the detected information and countermeasures against abnormalities.

The carbon dioxide recovery method performed in the recovery apparatus 1 configured as described above includes, as the main process, drying treatment, separation processing, regeneration treatment, and switching processing. In the drying treatment, the gas supplied to the separation processing is dried using a hygroscopic agent. In the separation processing, carbon dioxide is separated from the dried gas, and the residual gas obtained by separating carbon dioxide is discharged. In the regeneration treatment, the regeneration gas introduced from outside is supplied to the hygroscopic agent used in the drying treatment. In the switching processing, the regeneration gas supplied to the hygroscopic agent is switched to the residual gas in accordance with the progress of regeneration of the hygroscopic agent. In detail, the following operations are performed.

The gas G to be supplied is subjected to the cooling treatment in the cooler to be cooled to a temperature of about 50° C. or lower, preferably about 40° C. or lower, and it is then pressurized to a pressure at which the separation processing of carbon dioxide is performed (pressure at which carbon dioxide can be liquefied). In this pressurization, a pressure of about 2.0 to 4.0 MPa is generally employed. For example, in the embodiment of FIG. 1, the gas G is pressurized to about 0.5 MPa by the compressor 3 and to about 2.5 MPa by the compressor 5. The temperature of the pressurized gas G is increased to about 180 to 250° C. and the gas G is subjected to cooling by the heat exchanger 13 to be cooled to a temperature of about 120° C. or lower, before being subjected to the drying treatment and the separation processing. The gas G is further cooled in the cooler 14 of water-cooling type as necessary. The extent of cooling in the cooler 14 is controlled based on the temperature detected by the thermometer 16, and the temperature is lowered to a temperature suitable for the drying treatment in the dryer DR, specifically to a temperature of about 50° C. or lower, preferably about 40° C. or lower, more preferably about 30° C. or lower. In the case where denitration processing of the gas G is necessary, it is applied to the gas G after pressurized.

Thereafter, the gas G is subjected to the drying treatment by the dryer DR and the moisture content thereof is reduced to about 1 ppm or less. The gas G after subjected to the drying treatment is separated into carbon dioxide C and the residual gas G′ (separation processing) in the separator SP. If the temperature of the gas G is higher than the temperature suitable for the separation processing, the gas G may be suitably cooled as necessary by utilizing an appropriate cooler in the stage prior to the separation processing. The cooling method of the gas G is not limited to a particular method provided that the method involves no humidification. For example, it may be appropriately selected from well-known indirect contact-type cooling techniques such as of water-cooling type, air-cooling type, etc., and it can be satisfactorily implemented by cooling of water-cooling type.

The dried gas G is subjected to liquefaction and cryogenic separation by the separation processing in the separator SP, and purified carbon dioxide C is obtained. For example, when a gas G having a carbon dioxide concentration of 80 to 90%, a temperature of 30° C., and a pressure of 2.5 MPa is supplied to the separator SP, liquefied carbon dioxide C having a concentration of about 95 to 99% is recovered. As a residue of separation and refining, the residual gas G′ having a carbon dioxide concentration of about 30% is discharged from the separator SP at a pressure of about 2.4 MPa and a temperature of about 20° C. Other components that may be contained in the residual gas G′ include nitrogen, argon, carbon monoxide, oxygen and the like.

In parallel with the separation processing described above, the regeneration treatment using the regeneration gas N, in the dryer DR, is performed on the hygroscopic agent H not subjected to the drying treatment, or, the hygroscopic agent H after use. Meanwhile, the recirculation processing is performed so that the residual gas G′ separated and discharged in the separation processing is merged with the gas G before supplied to the separator SP. Since the pressure of the gas G that the residual gas G′ has joined by the recirculation processing increases, the compressibility of the compressor 5 is set in consideration of this pressure increment.

In the regeneration treatment, the regeneration gas N introduced from outside is heated on the heat exchanger 13 with the pressurized gas G, whose temperature is raised to about 150 to 200° C., and becomes high-temperature dry gas which contains almost no moisture and has a dew point of about −90 to −60° C. Further, after supplemental heating in the heater 15, the regeneration gas N of about 200 is supplied to the dryer DR and is used for the regeneration treatment. The regeneration gas N after used for the regeneration treatment contains moisture of about 10 to 100 ppm and it is discharged from the dryer DR. In order to continuously and efficiently perform the drying treatment of the gas G, the supply flow rate of the regeneration gas N is adjusted so that the time required for the regeneration treatment of the hygroscopic agent H is equal to or shorter than the time period during which the hygroscopic agent H reaches the moisture absorption capacity in the drying treatment (the time during which the drying treatment can be continued).

During the regeneration treatment, the moisture content of the used regeneration gas N is monitored in the hygrometer 21. In accordance with the progress of the regeneration of the hygroscopic agent, the switching processing for switching the regeneration gas N supplied to the hygroscopic agent H to the residual gas G′ is carried out. That is, when the detected humidity of the used regeneration gas N reaches the reference value for judging the completion of regeneration, the switching processing is performed. In the switching processing, the connection of the switching valves V5, V6 is switched, and the gas supplied for the regeneration treatment is changed from the regeneration gas N to the residual gas G′. By this switching processing, the regeneration gas N coming into contact with the hygroscopic agent H is replaced by the residual gas G′, that is, the carbon dioxide concentration of the gas in contact is increased. The execution timing of the switching processing can be changed and adjusted according to the setting of the reference value. When a value of around 10 ppm is set as the reference value, the switching processing is performed substantially corresponding to the completion of regeneration. When the reference value is set high, the connection is switched at an earlier time than the actual completion of regeneration, and the substitution by the residual gas G′ is carried out until the alternation of the drying treatment/regeneration treatment. In a situation in which the time required for completing the regeneration of the hygroscopic agent H cannot be shortened to the time during which the drying treatment can be continued or less, it is possible, for example, to assume, as the completion of regeneration, the state of the regeneration degree progressible in the time period during which the drying treatment can be continued, and to set the time with this regeneration degree to the end of the regeneration.

Since heating is not necessary for the gas replacement in the column with the residual gas G′, the heating by the heater 15 may be stopped at the same time as the switching processing. This is possible by controlling based on the humidity of the used regeneration gas N, which is similar to the switching processing, or it is also possible by setting in advance the heating time of the heater 15 based on the setting of the reference value.

In the drying treatment, when the time for the hygroscopic agent H to reach the moisture absorbing capacity has elapsed, the switching between the drying treatment and the regeneration treatment is performed in the dryer DR by switching the connection of the switching valves V1 to V4. The drying treatment is performed by the hygroscopic agent H after subjected to the regeneration treatment, and the regeneration treatment is performed in parallel on the hygroscopic agent H after use in the drying treatment. From the viewpoint of the utilization efficiency of the regeneration gas N and the residual gas G′, it is optimum that the sum of the time required for the regeneration treatment and the time required for the replacement with the residual gas G′ is equal to the time during which the drying treatment can be continued. In such a setting, the time difference between the switching time of the switching valves V5, V6 (the timing of performing switching processing between the regeneration gas N and the residual gas G′) and the switching timing of the switching valves V1 to V4 (alternation time of drying treatment/regeneration treatment) corresponds to the time required for the replacement with the residual gas G′.

As described above, the drying treatment/regeneration treatment in the dryer is repeatedly performed in parallel with the separation processing in the separator SP. When the regeneration of the hygroscopic agent H is completed in the regeneration treatment, the supply destination of the residual gas G′ is switched from the gas G being compressed (pressurized) to the regeneration treatment, and the gas to be supplied for the regeneration treatment is switched from the regeneration gas N to the residual gas G′. Therefore, the carbon dioxide concentration of the gas with which the hygroscopic agent H contacts after the regeneration treatment increases.

The composition of the combustion exhaust gas varies depending on the fuel and the combustion method. The exhaust gas generated by oxygen combustion generally contains about 80% of carbon dioxide, about 10% of nitrogen, and about 10% of oxygen (volume percentages) and, in addition to these, may contain a small amount of water vapor and impurities such as sulfur oxides, nitrogen oxides, chlorine, and mercury. When such a combustion gas is processed as the gas G, carbon dioxide concentrated to a high concentration of about 98% or more can be recovered from the separator SP. Since the gas G supplied to the separator SP has flowed through the dryer DR and water vapor has been removed therefrom, the residual gas G′ discharged from the separator SP contains almost no water vapor and there is no problem in use in place of the regeneration gas in the dryer DR, so that the regeneration can also proceed.

In the case of separating carbon dioxide from a gas whose nitrogen concentration is high and whose carbon dioxide concentration is relatively low, the configuration may be changed such that the gas is subjected to preprocessing in which the carbon dioxide concentration in the gas is increased in advance by subjecting the gas to adsorption processing using an adsorbent with selective adsorptivity for nitrogen such as crystalline hydrous aluminosilicate alkaline earth metal salt (zeolite). In this case, if the nitrogen adsorbed in the preprocessing can be recovered, it can be utilized as the regeneration gas N from the outside to use for the regeneration of the hygroscopic agent H.

A carbon dioxide recovery technique is provided, in which carbon dioxide contained in a mixed gas such as a combustion exhaust gas and a process exhaust gas is separated to efficiently produce carbon dioxide concentrated or refined to high concentration, and in which the influence on the recovery of carbon dioxide due to the regeneration of the hygroscopic agent used for drying the gas is possibly reduced. It is an economically advantageous treatment technology that is useful as a comprehensive exhaust gas treatment in combustion facilities such as thermal power plants, steelworks, and boilers since it effectively uses a gas discharged in other equipment, and can contribute to the construction of energy supply technology in account of environmental protection.

Although the embodiment of the present disclosure has been described above with reference to the accompanying drawings, the present disclosure is not limited to such embodiment. Moreover, it must be understood that various changes or modifications that can be conceived by those skilled in the art are naturally also within the technical scope of the present disclosure, in the scope described in the claims.

What is claimed is:

1. A carbon dioxide recovery apparatus, comprising:
a dryer having a hygroscopic agent for drying a gas;
a separator which separates carbon dioxide from the gas dried by the dryer and discharges a residual gas from which carbon dioxide has been separated;
an introduction part which introduces from outside a regeneration gas for regenerating the hygroscopic agent;
a regeneration system capable of supplying one of the regeneration gas introduced from the introduction part and the residual gas discharged from the separator, to the dryer; and
a switching mechanism which switches supply by the regeneration system between the regeneration gas and the residual gas in response to regeneration of the hygroscopic agent.

2. The carbon dioxide recovery apparatus according to claim 1, further comprising:
a recirculating system capable of supplying the residual gas discharged from the separator to the gas to be supplied to the separator,
wherein the switching mechanism switches supply by the recirculating system so that the residual gas is supplied to the gas to be supplied to the separator while the regeneration gas is supplied to the dryer by the regeneration system.

3. The carbon dioxide recovery apparatus according to claim 1, wherein the switching mechanism includes:
a control system which controls switching so that the regeneration gas is supplied to the dryer at a start of regeneration of the hygroscopic agent and the residual gas is supplied to the dryer at an end of regeneration of the hygroscopic agent to replace the regeneration gas with the residual gas.

4. The carbon dioxide recovery apparatus according to claim 3, wherein the control system has a hygrometer which detects humidity of the regeneration gas discharged from the dryer and controls the switching based on the humidity detected by the hygrometer.

5. The carbon dioxide recovery apparatus according to claim 1, further comprising:
a compressor which compresses the gas to be supplied to the separator to pressurize the gas to a pressure suitable for separation of carbon dioxide by the separator; and
a heat exchanger which performs heat exchange between the gas whose temperature has been increased by compression by the compressor and one of the residual gas and the regeneration gas to be supplied to the dryer,
wherein the one of the regeneration gas and the residual gas is heated by the heat exchanger, and the gas is cooled.

6. The carbon dioxide recovery apparatus according to claim 5, wherein the separator includes a cryogenic-type liquefaction distillation apparatus.

7. The carbon dioxide recovery apparatus according to claim 5, further comprising:
a heater which complementarily heats the regeneration gas heated by the heat exchanger; and
an adjustment mechanism which adjusts heating of the regeneration gas by the heater.

8. The carbon dioxide recovery apparatus according to claim 7, wherein the adjustment mechanism adjusts heating by the heater so that the regeneration gas decreases in temperature as regeneration of the hygroscopic agent progresses.

9. The carbon dioxide recovery apparatus according to claim 7, wherein the adjustment mechanism adjusts heating by the heater based on humidity of the regeneration gas discharged from the dryer.

10. The carbon dioxide recovery apparatus according to claim 4, wherein the separator has a discharge part for discharging the residual gas,
the switching mechanism has a switching valve capable of switching a connection to the dryer between the discharge part of the separator and the introduction part, and
the switching valve is controlled according to the humidity detected by the hygrometer.

11. The carbon dioxide recovery apparatus according to claim 2, wherein the switching mechanism includes:
a control system which controls switching so that the regeneration gas is supplied to the dryer at a start of regeneration of the hygroscopic agent and the residual gas is supplied to the dryer at an end of regeneration of the hygroscopic agent to replace the regeneration gas with the residual gas.

12. The carbon dioxide recovery apparatus according to claim 2, further comprising:
a compressor which compresses the gas to be supplied to the separator to pressurize the gas to a pressure suitable for separation of carbon dioxide by the separator; and
a heat exchanger which performs heat exchange between the gas whose temperature has been increased by compression by the compressor and one of the residual gas and the regeneration gas to be supplied to the dryer,
wherein the one of the regeneration gas and the residual gas is heated by the heat exchanger, and the gas is cooled.

13. The carbon dioxide recovery apparatus according to claim 3, further comprising:
a compressor which compresses the gas to be supplied to the separator to pressurize the gas to a pressure suitable for separation of carbon dioxide by the separator; and
a heat exchanger which performs heat exchange between the gas whose temperature has been increased by compression by the compressor and one of the residual gas and the regeneration gas to be supplied to the dryer,
wherein the one of the regeneration gas and the residual gas is heated by the heat exchanger, and the gas is cooled.

14. The carbon dioxide recovery apparatus according to claim 4, further comprising:
a compressor which compresses the gas to be supplied to the separator to pressurize the gas to a pressure suitable for separation of carbon dioxide by the separator; and
a heat exchanger which performs heat exchange between the gas whose temperature has been increased by compression by the compressor and one of the residual gas and the regeneration gas to be supplied to the dryer,
wherein the one of the regeneration gas and the residual gas is heated by the heat exchanger, and the gas is cooled.

15. The carbon dioxide recovery apparatus according to claim 6, further comprising:
a heater which complementarily heats the regeneration gas heated by the heat exchanger; and
an adjustment mechanism which adjusts heating of the regeneration gas by the heater.

16. The carbon dioxide recovery apparatus according to claim 8, wherein the adjustment mechanism adjusts heating by the heater based on humidity of the regeneration gas discharged from the dryer.

17. A carbon dioxide recovery method, comprising:
drying treatment of drying a gas by using a hygroscopic agent;
separation processing of separating carbon dioxide from the gas dried by the drying treatment and of discharging a residual gas from which carbon dioxide has been separated;
regeneration treatment of supplying to the hygroscopic agent a regeneration gas introduced from outside to regenerate the hygroscopic agent;
switching processing of switching the regeneration gas supplied to the hygroscopic agent into the residual gas in accordance with progress of the regeneration of the hygroscopic agent.
